(19) United States
(12) Patent Application Publication
(10) Pub. No.: US 2017/0215236 A1
(43) Pub. Date: Jul. 27, 2017

(54) COOKTOP WITH GLASS CERAMIC COOKING PLATE

(71) Applicant: SCHOTT AG, Mainz (DE)

(72) Inventors: Birgit Doerk, Mainz (DE); Matthias Bockmeyer, Mainz (DE); Thomas Zenker, Nieder-Olm (DE); Evelin Weiss, Mainz (DE); Gerold Ohl, Sulzheim (DE); Martin Taplan, Mainz (DE); Roland Dudek, Bad Kreuznach (DE); Sascha Backes, Ruedesheim (DE)

(73) Assignee: SCHOTT AG, Mainz (DE)

(21) Appl. No.: 15/411,362

(22) Filed: Jan. 20, 2017

(30) Foreign Application Priority Data
Jan. 21, 2016 (DE) 102016101036.7

(51) Int. Cl. H05B 3/68; C03C 4/02; C03C 10/00; H05B 3/74; H05B 6/12

(52) U.S. Cl. CPC H05B 3/688; H05B 3/74; H05B 6/1209; C03C 10/0027; C03C 4/02; H05B 2213/07; C03C 2204/00

(57) ABSTRACT

A cooktop is provided that has a glass ceramic cooking plate, at least one heater arranged below the glass ceramic cooking plate, and at least one touch sensor. The touch sensor is operable across the glass ceramic cooking plate for adjusting the power of the at least one heater. The glass ceramic cooking plate has an increased strength and is therefore produced with a reduced thickness, whereby the sensitivity and reliability of the touch sensor is significantly improved.

### CROSS REFERENCE TO RELATED APPLICATIONS

This application claims benefit under 35 U.S.C. §119(a) of German Patent Application No. 10 2016 101 036.7 filed Jan. 21, 2016, the entire contents of which are incorporated herein by reference.

### BACKGROUND

1. Field of the Invention

The invention relates to a cooktop comprising a glass ceramic cooking plate and at least one heater arranged below the glass ceramic cooking plate.

2. Description of Related Art

Due to their low thermal expansion, glass ceramics based on lithium aluminosilicate are used for many applications where high temperatures and temperature differences are found. For example, glass ceramic plates are used as cooking plates of cooktops. The energy for cooking is provided by heaters arranged below the glass ceramic cooking plate. These may be halogen, radiant, or induction heaters, for example.

The manufacture of suitable glass ceramics and their use in the field of cooktops has been described in literature (e.g. “Low Thermal Expansion Glass Ceramics”, editor H. Bach, ISBN 3-540-58598-2). Starting with a green glass plate that is produced by a melting and subsequent shaping process, ceramization of the material is accomplished by a suitable temperature treatment during which initially nuclei are created on which so-called high-quartz mixed crystals (HQMK) will then grow controlled by an appropriate temperature-time curve. In contrast to the surrounding glass matrix, these HQMK have an orientation-dependent and negative thermal expansion coefficient. If a suitable ratio between the crystalline and the amorphous phase is given, a very low expansion coefficient of the glass ceramic is resulting over a wide temperature application range.

Such glass ceramic cooking plates are mostly dark colored in the visible range, with little or no light diffusion (haze). Dark colored glass ceramic cooking plates are employed in order to visually conceal the heaters and other components of the cooktop that are arranged below the glass ceramic cooking plate. The at least low diffusion makes it possible to arrange display elements underneath the glass ceramic cooking plate and to read them across the glass ceramic cooking plate from above.

Due to the low coefficient of thermal expansion and the high application temperatures, appropriate strengthening of the glass ceramic cooking plates is complicated. In order to nevertheless achieve the required strength, in particular the required impact strength and flexural strength, glass ceramic cooking plates are produced with a sufficient material thickness. Furthermore, it is known to provide knobs on the lower surface of the glass ceramic cooking plate which, when in use, is predominantly subjected to tensile stress. The knobs separate the areas of highest tensile stress in the valleys between knobs from the areas of most severe surface defects which constitute potential crack starting points and which, for structural causes, arise on the top of the knobs. In this way it is possible to significantly increase the strength of the glass ceramic cooking plate. For prior art glass ceramic cooking plates this means, for example, that with a knobbed lower surface and with a material thickness of greater than or equal to 3.8 mm the strength requirements for the glass ceramic cooking plates are met. The requirements are specified by standards, such as EN 60335, UL 858, or CSA 22.2.

For operating cooktops it has been known to place touch sensors inside the cooktop and below the glass ceramic cooking plate, which sensors are effective across the glass ceramic cooking plate. Both, optically effective touch sensors operating in the infrared range, and capacitive touch sensors are employed. A switching process is triggered by placing a finger in the sensing area of a touch sensor on the upper surface of the glass ceramic cooking plate. In this way, the output power of a heater can be adjusted for example.

From DE 10 2006 059 850 A1, an optical sensor is known which comprises an emitter emitting electromagnetic radiation and a receiver receiving the radiation. The optical sensor serves as a touch-sensitive switch of a control device for an electronic household appliance, for example a glass ceramic cooktop. In such an application it is arranged below a glass ceramic cooking plate that serves as a cover panel, so that the radiation emitted by the emitter passes through the glass ceramic cooking plate. A finger placed on the cooking plate and in the beam path causes part of the radiation to be reflected back through the glass ceramic to the receiver, whereby a switching process is triggered. Disadvantageously, as the electromagnetic radiation passes twice through the comparatively thick glass ceramic cooking plate, a large proportion of the radiation is absorbed thereby. This causes losses in sensitivity and signal-to-noise ratio of the optical sensor. A further disadvantageous effect on the directed propagation of the electromagnetic radiation is caused by knobs that are formed on the lower surface of the glass ceramic cooking plate.

The inherent color and low transmittance of the glass ceramic cooking plate in the visible spectral range have an unfavorable effect on the desired recognizability and color appearance of signal lamps and displays which are provided below the glass ceramic cooking plate for certain applications. Likewise unfavorably, the knobs have a distorting effect on the visual perception of displays arranged underneath the glass ceramic cooking plate. This effect is further enhanced by the fact that the displays are often arranged with a spacing to the glass ceramic cooking plate. This may be necessary, for example, in order to avoid overheating of the electronic component by rearward heating due to a placed hot pot.

DE 10 2011 050 867 A1 discloses a glass ceramic cooking plate of dark coloration in the visible light range. The employed glass ceramic material comprises high-quartz mixed crystals (HQMK) as the predominant crystal phase. The glass ceramic cooking plate is distinguished by a lower surface that is flat, non-patterned and plane-parallel to the upper surface. This makes it possible to realize displays which are visually perceived with significantly better definition as compared to a knobbed cooking plate. Coatings can be applied to the lower surface with sharply defined contours. Thus, electrodes of touch-sensitive sensors (touch sensors) and of pot and pot size sensors can be produced with sharp contours. The glass ceramic cooking plate can be provided with the glass ceramic material used in thicknesses between 2 and 6 mm and have a sufficient mechanical stability. However, it is not described by virtue of which measures the glass ceramic achieves sufficient strength in compliance with the aforementioned standards in case of a smooth lower surface and a thickness of less than 4 mm.

### SUMMARY

An object of the invention is to provide a cooktop comprising a volume-dyed glass ceramic cooking plate which exhibits no or only slight diffusion in the visible wavelength range and which ensures high functional reliability of touch sensors arranged below the glass ceramic cooking plate and at the same time has sufficient mechanical strength to meet the standard requirements.

The object of the invention is achieved by a cooktop comprising a glass ceramic cooking plate and at least one heater arranged below the glass ceramic cooking plate, and further comprising a touch sensor operable across the glass ceramic cooking plate for adjusting the power of the at least one heater, which is indirectly or directly connected to or urged against the glass ceramic cooking plate or is arranged spaced therefrom, wherein the glass ceramic cooking plate is made of a lithium aluminosilicate glass ceramic (LAS glass ceramic) containing the following constituents in the following composition (in percent by weight):

| | |
|---|---|
| Al₂O₃ | 18-23 |
| Li₂O | 2.5-4.2 |
| SiO₂ | 60-69 |
| ZnO | 0-2 |
| Na₂O + K₂O | 0.2-1.5 |
| MgO | 0-1.5 |
| CaO + SrO + BaO | 0-4 |
| B₂O₃ | 0-2 |
| TiO₂ | 2.3-4.5 |
| ZrO₂ | 0.5-2 |
| P₂O₅ | 0-3 |
| SnO₂ | 0-<0.6 |
| Sb₂O₃ | 0-1.5 |
| As₂O₃ | 0-1.5 |
| TiO₂ + ZrO₂ + SnO₂ | 3.8-6 |
| V₂O₅ | 0.01-0.08 |
| Fe₂O₃ | 0.03-0.3, |

and optionally further coloring oxides, in total up to a maximum amount of 1.0 wt %, wherein the glass ceramic cooking plate has a core and includes keatite mixed crystal (KMK) as the predominant crystal phase in the core, wherein in a depth of 10 μm or more, the KMK crystal phase content exceeds 50% of the total of HQMK and KMK crystal phase contents, and wherein the glass ceramic cooking plate has a thickness in a range between 2.8 mm and 3.5 mm, preferably between 2.8 mm and 3.2 mm.

In a preferred embodiment of the cooktop, the glass ceramic cooking plate has a gradient layer at the surface or towards the surface thereof and the core is located below this gradient layer, and the glass ceramic cooking plate includes keatite mixed crystal (KMK) as the predominant crystal phase in the core and high-quartz mixed crystal (HQMK) as the predominant crystal phase in the gradient layer.

Advantageously, at a wavelength of 630 nm, maximum haze is not more than 6%, preferably not more than 5%, most preferably not more than 4%.

Preferably, it may be contemplated in this case that the Li₂O content is between 3.0 and 4.2 percent by weight. Also, the TiO₂ content may preferably be limited to a range from 2.3 to 4.0 percent by weight. The Fe₂O₃ content is most preferably from 0.03 to 0.2 percent by weight.

Such a glass ceramic cooking plate has a dark coloration in the visible wavelength range and at the same time exhibits low diffusion (haze).

It has been found, surprisingly, that the glass ceramic cooking plate of the above-mentioned composition and the described layer structure has an increased strength as compared to prior art LAS glass ceramic cooking plates. Therefore it is possible to reduce the thickness of the glass ceramic cooking plate, which is usually 4 mm, while the relevant standard specifications (EN 60335, UL 858, or CSA 22.2) for the required impact resistance of glass ceramic cooktops will still be met. As a result of the reduced thickness of the glass ceramic cooking plate of 3.2 mm, for example, the sensitivity and signal-to-noise ratio and thus switching reliability of touch sensors arranged below and effective across the glass ceramic cooking plate is significantly improved. Thus, a cooktop is provided which meets the standard requirements on strength of the glass ceramic cooking plate and at the same time provides for improved and more reliable controllability by means of touch switches that are arranged underneath the glass ceramic cooking plate, compared to what is known from today's prior art cooktops.

For producing a glass ceramic cooking plate suitable for this purpose, first a green glass of the aforementioned composition is melted, then shaped into the desired plate shape and appropriately cut. During a subsequent ceramization process, a pre-crystallized glass ceramic intermediate product is produced, with high-quartz mixed crystal (HQMK) as the predominant crystal phase. By a further crystal conversion step, the HQMK phase is partially converted into a keatite mixed crystal phase. This conversion step takes place at a maximum temperature Tₘₐₓ which is maintained for a predetermined holding time t(Tₘₐₓ). Suitable holding times and maximum temperatures are given by a temperature-time range which is limited by four straight lines. In the present case, the straight lines connect vertices of the temperature-time range with the values pairs (Tₘₐₓ=910° C.; t(Tₘₐₓ)=25 minutes), (Tₘₐₓ=960° C.; t(Tₘₐₓ)=1 minute), (Tₘₐₓ=980° C.; t(Tₘₐₓ)=1 minute), and (Tₘₐₓ=965° C.; t(Tₘₐₓ)=25 minutes).

Advantageously, the at least one touch sensor can be a capacitive sensor or an optical sensor, in particular an infrared sensor. A capacitively operating touch sensor has at least one electrode at which or between which a time-varying electrical field is generated. The electrical field is effective across the glass ceramic cooking plate. A finger that is introduced into the alternating electrical field changes the capacitance of the capacitor defined by the electrodes, whereby due to a modified voltage or current signal a switching process is triggered. For example, the sensitivity of a capacitive touch switch arranged below a glass ceramic cooking plate changes between an electrode and a finger (second electrode) according to the capacitor formula C=∈₀∈ᵣ*A/d according to the ratio of the change in thickness when the glass ceramic thickness d changes. Here, C is the capacitance of the capacitor, ∈₀ is the electric constant, ∈ᵣ is the dielectric constant, and A is the sensor area. Accordingly, when the thickness of the glass ceramic cooking plate changes from 4 mm to 3 mm, the sensitivity of the capacitive touch switch will change by 25%. This gain can be exploited for a more sensitive switching behavior of the touch switch. However, it is also possible to provide additional functional layers between the capacitive touch sensor and the glass ceramic cooking plate without impairing the sensitivity of the touch sensor as compared to the case where it is employed below a thicker glass ceramic cooking plate. It is also possible to reduce the sensor area A in correspondence to the change in thickness of the glass ceramic cooking plate without impairing the sensitivity, compared to a capacitive touch sensor that is arranged below a thicker glass ceramic cooking plate. With smaller sensor areas A it is possible to present finer sensor patterns.

In the case of an optical touch sensor (infrared sensor) and for a fixed opening angle of the emitting diode of the infrared radiation, a smaller area will be illuminated with a higher intensity per unit area in the case of a glass ceramic cooking plate of reduced thickness compared to a glass ceramic cooking plate of a larger thickness. The spatial resolution between adjacent optical touch sensors can thus be improved.

According to one embodiment of the invention it may be contemplated that, at least one light-emitting element and/or at least one self-luminous or externally illuminated display is arranged indirectly or directly adjacent to the lower surface of the glass ceramic or spaced from the lower surface of the glass ceramic cooking plate, and that the light-emitting element and/or the display shines through the glass ceramic cooking plate. The light-emitting elements or displays may for instance be adapted for displaying a power level set by means of the touch switches.

In case the display region below which the light-emitting element or display is arranged is masked on the upper surface of the glass ceramic cooking plate, the reduced thickness of the glass ceramic cooking plate will result in a smaller offset between the masking and the display or the light-emitting element. So, the light-emitting element or the display can be associated more precisely with the masking. At the same time, with a reduced thickness of the glass ceramic cooking plate, the angle under which a display or a light-emitting element can be seen through the exposed masking area increases. Moreover, for the same colorant concentration, the viewing angle under which a display or a light-emitting element can be seen with sufficient brightness also increases with a reduced thickness of the glass ceramic cooking plate. For this consideration, the viewing angle is defined as the angle at which just 50% of the light intensity is provided compared to the vertical and under the assumption of an isotropic emission characteristic of the light-emitting element or the display.

Furthermore, the reduction in the thickness of the glass ceramic cooking plate leads to a reduction in the discoloration of a display or of a light-emitting element (in particular in the case of wide-spectrum light-emitting elements or displays, especially in the case of white light) when the same colorant concentration of the glass ceramic cooking plate is assumed. In the context of the present invention, the ratio of the transmittance of the glass ceramic cooking plate for two wavelengths is considered as a measure of discoloration for the respective thicknesses. With the reduced discoloration, white balance for white displays and light-emitting elements can be improved. Originally white displays or light-emitting elements appear less discolored in case of a glass ceramic cooking plate of 3.0 mm thickness than with a glass ceramic cooking plate of 4 mm thickness. When the display or light-emitting element is looked at obliquely, discoloration will also be less in the case of a thinner glass ceramic cooking plate. Warning messages which are preferably output by light signals in different signal colors can thus be recognized better and error-free.

Distortion-free imaging of displays and light-emitting elements arranged below the glass ceramic cooking plate can be achieved by not providing a texture on the lower surface of the glass ceramic cooking plate. Because of the increased strength of the glass ceramic material used for producing the glass ceramic cooking plate, the otherwise common knobbed pattern on the lower surface of the glass ceramic cooking plate can be dispensed with, while the strength requirements on the glass ceramic cooking plate are still met. Without knobs and due to the low diffusion of the glass ceramic cooking plate in the visible wavelength range, the displays and light-emitting elements are imaged with precise contours across the glass ceramic surface. Therefore, if desired, the size of the displayed symbols, for example digits or characters, can be reduced. Furthermore it is possible to increase the resolution of the displayed symbols.

A non-textured, smooth lower surface of the glass ceramic cooking plate has also advantages for the use of touch sensors that are arranged below the glass ceramic cooking plate. In the case of an infrared sensor as a touch sensor, the emitted light and the light reflected back by a finger is no longer scattered irregularly on the knobs corresponding to many small lenses. As a result, more light reaches the associated touch zone on the glass ceramic upper surface and returns back to the receiver of the infrared sensor. So, the sensitivity of optical touch sensors is improved. In addition, the knobs cause local intensity variations which makes it difficult to set a signal threshold value for touch detection. This is eliminated in case of a smooth lower surface. The signal threshold value can be set with a smaller tolerance and therefore provides better sensitivity.

In the case of capacitively operating touch sensors, no dirt or moisture can accumulate in the knob valleys between the electrodes of the touch sensors and the glass ceramic cooking plate, so that interfering influences on the sensitive capacitive measurement can be avoided.

The properties of touch sensors, light-emitting elements and displays can be adapted to the respective requirements by providing a transparent and/or a colored transparent and/or a non-transparent and/or a light-diffusing intermediate layer between the touch sensor and/or the light-emitting element and/or the at least one display on the one side and the glass ceramic cooking plate on the other side. For example, a clear transparent intermediate layer may be applied onto a knobbed lower surface of a glass ceramic cooking plate so as to form a flat surface in parallel to the surface of the glass ceramic. If the refractive index of the intermediate layer is preferably matched with that of the glass ceramic cooking plate, the intermediate layer forms an immersion layer which at least reduces light refraction upon transition of the light from the immersion layer to the glass ceramic cooking plate. In this way, displays and light-emitting elements can be perceived without distortion or with only a slight distortion, for example if the refractive index of the immersion layer is not completely matched, even if the glass ceramic cooking plate is knobbed. If the immersion layer is also effective in the infrared range, this even permits to prevent undesired refractions of the infrared radiation of an optical touch sensor on the knobs, and as a result interfering influences on the functionality of the optical touch sensor can be avoided. The electrodes of capacitive touch sensors can be pressed against the immersion layer or can be materially bonded thereto. In this manner, moisture or dirt can be prevented from accumulating between the electrodes and the lower surface of the glass ceramic cooking plate and from impairing the function of the capacitive touch sensor.

A dyed transparent intermediate layer allows for subtractive color mixing so that the light emitted by a display or a light-emitting element has a desired color after having passed through the intermediate layer and the glass ceramic cooking plate. This permits color compensation of the inherent color of the glass ceramic cooking plate. A non-transparent intermediate layer may be used, for example, to mask a light-emitting element in order to display a symbol. With a non-transparent or strongly diffusing intermediate layer it is furthermore possible to avoid insight into the cooktop in the area of capacitive touch sensors.

The intermediate layer may be provided, for example, in the form of a layer that is applied directly to the lower surface of the glass ceramic cooking plate, or as a film.

According to a preferred embodiment variant of the invention it may be contemplated that the glass ceramic cooking plate is provided, on its lower surface at least in some areas thereof, with a diffusion light barrier that is not transparent in the visible spectral range. Such a non-transparent diffusion light barrier may preferably be arranged outside the hot regions and outside of indicator and display regions. It prevents an undesirable view into the cooktop even under strong incident light. This in particular also applies to a glass ceramic cooking plate with reduced thickness, which exhibits increased transparency in the visible range for the same intensity of volume coloration. The diffusion light barrier may encompass areas that remain uncoated, for example in the form of symbols. With appropriate backlighting, the symbols can then be perceived from above the glass ceramic cooking plate. If the lower surface of the glass ceramic cooking plate is smooth, the diffusion light barrier may be applied to the glass ceramic lower surface with exact contour definition, for example by a screen printing process. In this way, symbols can be represented with high resolution. Display regions and hot zones may also remain uncoated, with a sharp boundary line.

According to a further embodiment of the invention it may be contemplated that sensor area elements and/or sensor conductor tracks and/or sensor contact points are applied indirectly or directly on the glass ceramic cooking plate, and/or that sensor electrodes are indirectly or directly applied on or urged against the glass ceramic cooking plate. The sensor area elements or sensor conductor tracks may be formed, for example, by an electrically conductive partial coating of the glass ceramic lower surface. For this purpose, opaque or transparent electrically conductive materials can be used. The sensor electrodes, for example in the form of metal parts, may be pressed against the glass ceramic cooking plate from below. In combination with suitable evaluation electronics, such sensor configurations can be used to implement different features or functions. For example, inductive or capacitive detection of the pot or pot size may be accomplished. It is also possible to determine the temperature of the glass ceramic cooking plate in the hot zone. For this purpose, a change in the resistance of a sensor conductor track or of a glass ceramic section arranged between two sensor conductor tracks can be measured and evaluated accordingly, for example. On the basis of the temperature measurement, various control functions of the cooktop can be implemented. For example, overheating of the glass ceramic cooking plate can be avoided. Furthermore, power redistribution between the heating circuits of a multi-circuit heater can be effected, for example as a function of a given quality of a placed piece of cookware. Also conceivable is automated control of a cooking process on the basis of the sensed glass ceramic temperatures. The sensor configurations may furthermore be used as electrodes of capacitive touch sensors. When transparent electrodes are employed it is possible to arrange capacitively operating touch sensors between a display or a light-emitting element and the glass ceramic cooking plate. This for instance allows intuitive user guidance of the cooktop during which switching processes at touch sensors will trigger different events in dependence of the respective contents of the display arranged therebehind. Because of the reduced thickness of the glass ceramic cooking plate, the described sensors exhibit improved sensitivity. Thus, it is possible on the basis of the obtained sensor signals to perform controlling, switching, and closed-loop control processes with better accuracy and functional reliability. It is moreover advantageous if the glass ceramic lower surface is not textured but rather smooth. In this case, the sensor area elements, sensor conductor tracks and sensor electrodes may therefore be applied with a better contour accuracy and more uniform thickness to the lower surface of the glass ceramic cooking plate. Thus, capacitive, inductive, or resistive measurements that have to be performed for the desired functionalities can be effected with significantly improved accuracy. When the sensor electrodes are pressed against the surface, there will be no varying gap between the sensor electrodes and the glass ceramic, in contrast to a textured glass ceramic underside. This makes it possible, for example, to prevent dirt or moisture from entering between the electrodes and the glass ceramic cooking plate and from corrupting the measurement result.

In order to be able to clearly visualize displays and light-emitting elements, it may be contemplated that at a wavelength of 470 nm, maximum haze is not more than 15%, preferably not more than 12%, and/or that in a range of wavelengths from 400 nm to 500 nm, maximum haze is not more than 20%, preferably not more than 17%, normalized to a glass ceramic cooking plate of 4 mm thickness in each case, and/or that at a wavelength of 630 nm, maximum haze is not more than 6%, preferably not more than 5%, most particularly not more than 4%. Here, the fraction of diffused light is measured according to international standard ISO 14782: 1999(E). Thus, the glass ceramic cooking plate of the cooktop according to the invention is in particular different from prior art glass ceramic cooking plates which have a high keatite mixed-crystal content and which appear translucent or even opaque, due to a large number of scattering centers, and which are therefore not suitable for use in conjunction with displays.

In order to prevent an irritating view to the technical components of the cooktop arranged below the glass ceramic cooking plate and to avoid glaring effects caused by radiating heaters, in particular bright halogen heaters, it may be contemplated that in a range of wavelengths from 380 nm to 780 nm light transmittance is less than or equal to 5%, preferably 10%, normalized to a glass ceramic cooking plate of 4 mm thickness in each case.

Advantageously, at a wavelength of 420 nm spectral transmittance is greater than 0.2%

With light transmittance adjusted as described above, the glass ceramic cooking plate will have a black appearance under incident light. However, displays and light-emitting elements arranged below the glass ceramic cooking plate are easily visible and readable through the glass ceramic. Also, heaters in operation can be perceived in sufficient brightness.

Improved display capability of displays and light-emitting elements can be achieved if the glass ceramic cooking plate contains color-imparting metal ions and if in a display region the spectral transmittance of the glass ceramic cooking plate is increased in some areas as compared to an adjacent region due to local heating induced by electromagnetic radiation. In such display regions of increased transmittance, associated displays and light-emitting elements can be better recognized and read. Furthermore, the offset of the color coordinates of the display or light-emitting element is reduced in such a display region.

Good readability of a display arranged below the glass ceramic cooking plate and the display region and good perceptibility of a light-emitting element that is likewise arranged there can be achieved if in a wavelength range from 380 nm to 780 nm, light transmittance of the glass ceramic cooking plate in the display region is less than or equal to 2.5%, or if light transmittance is between 2.5% and 5%, or if light transmittance is less than or equal to 10%. With a light transmittance of less than or equal to 2.5%, insight into the cooktop can be reliably avoided even in the display region when the display or light-emitting unit is not illuminated. With a transmittance between 2.5% and 5% a good tradeoff is achieved between reduced insight into the cooktop when the display or light-emitting element is switched off and a good and bright representation of the display or light-emitting element in their switched-on state. A light transmittance of less than or equal to 10% permits to employ and reliably recognize even low-light and thus low-cost displays or light-emitting elements.

Advantageously, the display or the light-emitting element is arranged under a display region of the glass ceramic cooking plate that exhibits increased light transmittance compared to the surrounding glass ceramic material. On the one hand, this ensures good readability of the display or recognizability of the light-emitting element and, on the other hand, prevents insight into the cooktop in the glass ceramic material surrounding the display region.

### BRIEF DESCRIPTION OF THE DRAWINGS

The invention will now be described in more detail by way of exemplary embodiments and with reference to the accompanying drawings wherein the same reference numerals denote the same or equivalent elements, and wherein:

FIG. 1 schematically illustrates a section of a cooktop comprising a glass ceramic cooking plate, a heater and an electronic arrangement;

FIG. 2 schematically illustrates a section of a glass ceramic cooking plate with an optical touch sensor;

FIG. 3 schematically illustrates a section of a glass ceramic cooking plate with a capacitive touch sensor;

FIG. 4 schematically illustrates a section of a glass ceramic cooking plate with a light-emitting element and an upper surface coating;

FIG. 5 schematically illustrates a section of a glass ceramic cooking plate with a light-emitting element;

FIG. 6a is a schematic side view of a section of a glass ceramic cooking plate with a knobbed lower surface and a display;

FIG. 6b is a plan view of the portion of a glass ceramic cooking plate shown in FIG. 6a;

FIG. 7a is a schematic side view of a section of a glass ceramic cooking plate with a smooth lower surface and a display;

FIG. 7b is a plan view of the portion of a glass ceramic cooking plate shown in FIG. 7a;

FIG. 8a schematically illustrates a bottom view of a section of a glass ceramic cooking plate with a knobbed lower surface;

FIG. 8b schematically illustrates a bottom view of a section of a glass ceramic cooking plate with a non-textured lower surface;

FIG. 9a is a schematic side view of a section of a knobbed glass ceramic cooking plate;

FIG. 9b is a schematic side view of a section of a non-textured glass ceramic cooking plate;

FIG. 10 is a schematic side view of a section of a glass ceramic cooking plate with a display region; and

FIG. 11 is a schematic side view of a section of a cooktop with a glass ceramic cooking plate, a heater, and sensor electrodes.

### DETAILED DESCRIPTION

FIG. 1 schematically illustrates a section of a cooktop 10 comprising a glass ceramic cooking plate 11, a heater 12, and an electronic arrangement 20.

Heater 12 which in the present exemplary embodiment is a radiant heater is urged against a lower surface 11.2 of glass ceramic cooking plate 11 by means of spring elements 13 bearing against a bottom 14 of the cooktop. Heater 12 comprises a heating coil 12.2 and a protective temperature limiter 12.1. Protective temperature limiter 12.1 interrupts the power supply to the heating coil 12.2 when the temperature of the glass ceramic cooking plate 11 exceeds a predetermined threshold value. Heater 12 defines a hot zone which is marked as a cooking zone 15 on an upper surface 11.1 of glass ceramic cooking plate 11 and on which a piece of cookware, for example a cooking pot, can be placed. The cookware and the food to be cooked contained therein are heated by heater 12, as is symbolized by energy flow 30 as illustrated. Energy flow 30 is primarily composed of radiation energy emitted by heating coil 12.2 and of energy transferred by heat conduction in the region of glass ceramic cooking plate 11. The energy transfer from heater 12 to the cookware is subject to energy loss, as illustrated herein by the example of transverse heat conduction 31 within glass ceramic cooking plate 11. Glass ceramic cooking plate 11 has a thickness 50 as marked by a double arrow, which is reduced compared to prior art glass ceramic cooking plates. The plate is glued into a frame 16 of cooktop 10 by means of a flexible adhesive 16.1. Frame 16 is connected to the bottom 14 of the cooktop.

Electronic arrangement 20 is urged against the lower surface 11.2 of glass ceramic cooking plate 11 by means of a spring element 13. In the illustrated exemplary embodiment it comprises a display 21 and a touch sensor 22. Display 21 may be configured as a seven-segment display or a graphical display, for example. Electronic arrangement 20 is spaced from heater 12 by a spacing 53. In the illustrated exemplary embodiment, light-emitting elements 23 are arranged at the outer edge of heater 12, as a self-luminous cooking zone marking.

The glass ceramic cooking plate 11 of the invention has the following composition, given in percent by weight:

| | |
|---|---|
| Al₂O₃ | 18-23 |
| Li₂O | 2.5-4.2 |
| SiO₂ | 60-69 |
| ZnO | 0-2 |
| Na₂O + K₂O | 0.2-1.5 |
| MgO | 0-1.5 |
| CaO + SrO + BaO | 0-4 |
| B₂O₃ | 0-2 |
| TiO₂ | 2.3-4.5 |
| ZrO₂ | 0.5-2 |
| P₂O₅ | 0-3 |
| SnO₂ | 0-<0.6 |
| Sb₂O₃ | 0-1.5 |
| As₂O₃ | 0-1.5 |
| TiO₂ + ZrO₂ + SnO₂ | 3.8-6 |
| V₂O₅ | 0.01-0.08 |
| Fe₂O₃ | 0.03-0.3. |

In addition, further coloring oxides may be contained in an amount of up to at most 1.0 wt %. In this case, the Li₂O content is preferably limited to a range from 3.0 to 4.2 wt %, the TiO₂ content is preferably limited to a range from 2.3 to 4.0 wt %, and the Fe₂O₃ content to a range from 0.03 to 0.2 wt %.

For producing the glass ceramic cooking plate 11 according to the invention, first a green glass of the aforementioned composition is melted, then shaped into the desired plate shape and appropriately cut. During a subsequent ceramization process, a pre-crystallized glass ceramic intermediate product is produced, with high-quartz mixed crystal (HQMK) as the predominant crystal phase. By a further crystal conversion step, the HQMK phase is partially converted into a keatite mixed crystal phase. This conversion step takes place at a maximum temperature Tₘₐₓ which is maintained for a predetermined holding time t(Tₘₐₓ). Suitable holding times and maximum temperatures are given by a temperature-time range which is limited by four straight lines. In the present case, the straight lines connect vertices of the temperature-time range with the values pairs (Tₘₐₓ=910° C.; t(Tₘₐₓ)=25 minutes), (Tₘₐₓ=960° C.; t(Tₘₐₓ)=1 minute), (Tₘₐₓ=980° C.; t(Tₘₐₓ)=1 minute), and (Tₘₐₓ=965° C.; t(Tₘₐₓ)=25 minutes).

With the composition and the production process described above, a glass ceramic cooking plate 11 is obtained which comprises a gradient layer toward the surface of the glass ceramic cooking plate 11 and an underlying core. The core includes keatite mixed crystal (KMK) as the predominant crystal phase. The gradient layer includes high-quartz mixed crystal (HQMK) as the predominant crystal phase. Starting from the surface of the glass ceramic cooking plate, the KMK crystal phase content exceeds 50% of the total of the HQMK and KMK crystal phase contents in a depth of 10 μm or more. Preferably, an amorphous layer is additionally provided above the gradient layer.

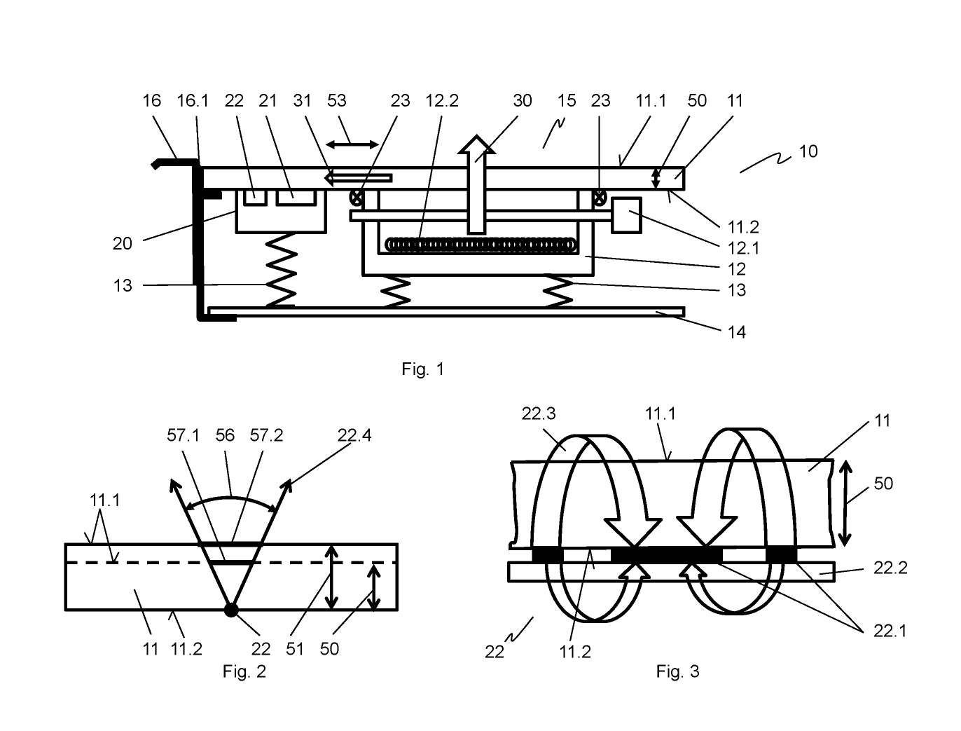

The so produced glass ceramic cooking plate 11 with the abovementioned composition exhibits increased strength as compared to prior art LAS-based glass ceramic cooking plates 11 of the same material thickness. Therefore, glass ceramic cooking plates 11 that have a reduced thickness 50 as compared to the usual thickness 51, as indicated in FIG. 2, can be employed for cooktops 10. In this case, the strength requirements specified in relevant standards (EN 60335, UL 858, CSA 22.2) are still complied with. Glass ceramic cooking plates 11 that are employed in the field of private domestic appliances usually have a thickness 51 in a range from 3.8 to 4.2 mm. The glass ceramic cooking plates 11 of the invention, by contrast, can be used with a thickness 50 reduced to greater than or equal to 2.8 mm, while the above-mentioned standard requirements with respect to the strength of the glass ceramic cooking plates 11 are still met.

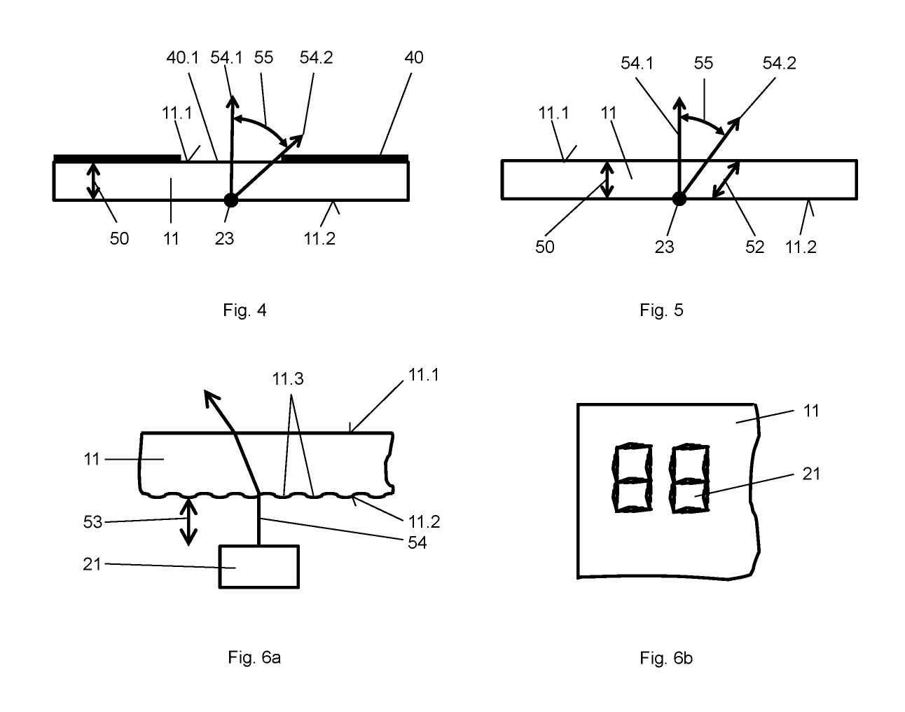

Such a reduced thickness 50 of the glass ceramic cooking plate 11 implies substantial improvements in the operation of the cooktop 10. As will be explained in more detail with reference to FIGS. 2 and 3, the reduced thickness 50 significantly improves the response behavior of touch sensors 22. As will be explained with reference to FIGS. 4 and 5, the reduced thickness 50 also significantly improves the transfer of information by means of displays 21 or light-emitting elements 23 which are arranged underneath the glass ceramic cooking plate 11. For example, as the parallax error is reduced in case of a reduced thickness 50 of the glass ceramic cooking plate 11, the cooking zone marking provided by light-emitting elements 23 in the exemplary embodiment of FIG. 1 can be associated more precisely with the actual position of the heater 12, even under an oblique viewing angle.

Furthermore, as a result of the reduced thickness 50 the energy flow 30 from heater 12 to a placed piece of cookware, not shown, is also improved. The thermal mass defined by the glass ceramic cooking plate 11 is reduced, which results in a quicker response to changes in the output power of heater 12 and therefore in improved controllability of a cooking process. Moreover, a greater portion of the heat radiation emitted by heating coil 12.2 reaches the placed piece of cookware.

Energy losses of the cooktop are also reduced in the case of a reduced thickness 50 of glass ceramic cooking plate 11. For the same specific heat capacity of the glass ceramic, the amount of heat E stored therein in the region of cooking zone 15 decreases proportionally to the intended thickness reduction according to the formula:

ΔE=π·r²·d· [symbol] ·cp·ΔT.

In the equation, r is the radius of cooking zone 15, d is the respective thickness 50, 51 of the glass ceramic cooking plate 11, [symbol] is the density (2.6 g/cm³), cp is the specific heat capacity (0.8 J/(g·J)) of the glass ceramic, and ΔT is a temperature increase effected in the region of cooking zone 15. For a cooking zone diameter of 180 mm and a temperature increase by 500 K, a change in the amount of heat of 29.3 Wh is resulting for a glass ceramic cooking plate 11 of 4 mm thickness, while for a glass ceramic cooking plate 11 of 3 mm thickness the amount of heat only changes by 22.1 Wh. Thus, energy saving amounts to approximately 7.3 Wh, which corresponds to 25%.

Transverse heat conduction 31 as a cause of energy losses also decreases proportionally to the reduction made in the thickness of the glass ceramic. According to the equation

ΔQ=(λ·A·t·ΔT)/I

the energy loss ΔQ attributable to transverse heat conduction 31 also changes by 25% for a 25% change in thickness. In the equation, λ denotes thermal conductivity (1.6 W/(m·K)), A is the cross-sectional area in the propagation direction of the energy flow, t is the duration of the heat transport, ΔT is the temperature difference between the hot zone and a surrounding cold region, and I is the spacing between the hot zone and the cold region.

Further energy savings are resulting from the fact that with a reduced thickness 50 of the glass ceramic cooking plate 11 a lower temperature difference is required between the glass ceramic lower surface 11.2 and the glass ceramic upper surface 11.1 in order to transfer, by heat conduction, a specific amount of energy per unit of time through the glass ceramic cooking plate 11. Thus, the temperature of the glass ceramic lower surface can be selected so as to be lower for a thinner glass ceramic cooking plate than in case of a thicker glass ceramic cooking plate, which causes lower energy losses to the environment.

The glass ceramic cooking plate 11 of the invention has a suitable coloration in the visible wavelength range and at the same time exhibits low diffusion (haze). Therefore, displays 21 and light-emitting elements 23 can be perceived and read looking through the glass ceramic cooking plate 11. Losses by diffused light are not existent or are only low. At the same time, the coloration prevents an undesirable view through the glass ceramic cooking plate 11 into the cooktop 10.

FIG. 2 schematically illustrates a section of a glass ceramic cooking plate 11 with an optical touch sensor 22.

For the sake of simplified illustration, only the emitting diode of optical touch sensor 22 is shown on the lower surface 11.2 of glass ceramic cooking plate 11. It emits infrared radiation 22.4 through the glass ceramic cooking plate 11 with a fixed opening angle 56.

In the simplified view which is not drawn to scale, the glass ceramic cooking plate 11 is initially illustrated with a usual thickness 51 of 4 mm. A dashed line indicates the location of the upper surface 11.1 of the glass ceramic cooking plate 11 if the glass ceramic cooking plate 11 has a reduced thickness 50 of 3.0 mm in the present case. The outer rays of infrared radiation 22.4 delimit an illuminated area 57.1, 57.2 on the respective surface 11.1 of a glass ceramic cooking plate 11 of usual thickness 51 and of reduced thickness 50. Here, the first illuminated area 57.1 is associated with a glass ceramic cooking plate 11 of reduced thickness 50, and the second illuminated area 57.2 is associated with a glass ceramic cooking plate 11 of the usual thickness 51.

As illustrated in the view of FIG. 2, for thinner material the illuminated area 57.1, 57.2 is reduced proportionally to the ratio of the squared respective thicknesses 50, 51. Thus, for a change in thickness from 4 mm to 3 mm, a ratio of 9/16=0.5625 is obtained between the first illuminated area 57.1 and the second illuminated area 57.2. Accordingly, for a fixed opening angle 56 of the emitting diode, a smaller area 57.1 will therefore be illuminated with a higher intensity per unit area in the case of a glass ceramic cooking plate 11 of reduced thickness 50. This permits to improve the resolution between adjacent optical touch sensors 22. It is moreover conceivable, for the same sensitivity of optical touch sensor 22, to reduce the emitted power of the emitting diode in the case of glass ceramic cooking plates 11 of reduced thickness 50 compared to a thicker glass ceramic cooking plate 11.

FIG. 3 schematically illustrates a section of a glass ceramic cooking plate 11 with a capacitive touch sensor 22. The electrode 22.1 of capacitive touch sensor 22 is applied on a circuit board 22.2 and pressed against the lower surface 11.2 of glass ceramic cooking plate 11. When the electrode 22.1 is appropriately driven electronically, an electrical field 22.3 is generated which penetrates the inventive glass ceramic cooking plate 11 of reduced thickness 50. Furthermore, embodiments of capacitive touch sensors with more than one electrode can also be employed in the context of the invention.

If a finger or an electrically conductive touching utensil is placed on the upper surface 11.1 of glass ceramic cooking plate 11 in the region of the electrical field 22.3, this will cause a change in the capacitance between electrode 22.1 and the previously free space, then the finger. This is evaluated by capacitive touch sensor 22 and interpreted as a switching signal.

More broadly, with a change in the thickness d of a glass ceramic, the sensitivity of capacitive sensors changes according to the ratio of the change in thickness, according to the capacitor formula

C=∈₀∈ᵣ*A/d.

Here, C is the capacitance of the capacitor, ∈₀ is the electrical field constant, ∈ᵣ is the dielectric constant, and A is the effective capacitor area between electrode 22.1 and the finger. When the thickness 50, 51 of glass ceramic cooking plate 11 is reduced from 4 mm to 3 mm, the sensitivity of capacitive touch sensor 22 increases to 4/3=1.25, i.e. by 25%. This can be exploited for several possible advantages. First, the increased sensitivity and the improved signal-to-noise ratio can be exploited to improve the reliability of the capacitive touch sensor 22. Furthermore, the improved sensitivity can be exploited for arranging additional functional layers between the capacitive touch sensor 22 and the lower surface 11.2 of glass ceramic cooking plate 11, such as, e.g., an immersion layer or a film with a thick immersion-effective adhesive layer. The additional layer and the glass ceramic cooking plate 11 are preferably matched to each other so that the overall sensitivity of the capacitive touch sensor 22 corresponds to that of an application below a glass ceramic cooking plate 11 of usual thickness 51 and without additional layer. It is moreover conceivable to reduce the sensing area A of capacitive touch sensor 22, i.e. in particular the surface area of electrodes 22.1, in correspondence to the achieved increase in sensitivity. This measure allows to achieve finer sensor structures.

In the arrangement shown in FIG. 3, the lower surface 11.2 of glass ceramic cooking plate 11 is advantageously not textured, in particular not knobbed. Therefore, electrode 22.1 directly engages the lower surface 11.2 of glass ceramic cooking plate 11. Valleys between knobs in which dirt or moisture could accumulate between the lower surface 11.2 of glass ceramic cooking plate 11 and the electrode 22.1 are thus avoided. In this way, reliability of the capacitive touch sensor 22 is significantly improved.

FIG. 4 schematically illustrates a section of a glass ceramic cooking plate 11 with a light-emitting element 23 and an upper surface coating 40.

In the highly schematic drawing which is not drawn to scale, a light-emitting element 23 is arranged directly on the lower surface 11.2 of a glass ceramic cooking plate 11. Glass ceramic cooking plate 11 has a reduced thickness 50 of 3.2 mm in the present exemplary embodiment. Upper surface coating 40 is applied on the upper surface 11.1 of glass ceramic cooking plate 11. Upper surface coating 40 may be a ceramic ink, for example, which was applied to the upper surface of the green glass prior to the ceramization process and was baked during ceramization. Upper surface coating 40 is opaque.

Upper surface coating 40 has a recess 40.1 opposite to light-emitting element 23, through which the light from light-emitting element 23 can exit from glass ceramic cooking plate 11. Shown is a light beam 54.1 extending perpendicularly to glass ceramic cooking plate 11 and a light beam 54.2 extending obliquely thereto. The oblique light beam 54.2, starting from light-emitting element 23, is directed towards the edge of the recess 40.1. Vertical light beam 54.1 and obliquely extending light beam 54.2 define a maximum possible viewing angle 55 therebetween, under which a light beam emanating from light-emitting element 23 is able to exit through the recess 40.1 in the upper surface coating 40.

As can first be seen from the illustration in FIG. 4 with respect to the recess 40.1, in the case of reduced thickness 50 of the glass ceramic cooking plate 11 the parallax resulting when obliquely looking at light-emitting element 23 or display 21 arranged below glass ceramic cooking plate 11 is reduced as compared to a thicker glass ceramic cooking plate 11.

As can furthermore be seen from the illustration, the maximum viewing angle 55 under which a light-emitting element 23 or display 21 arranged opposed to recess 40.1 can still be seen increases, assuming the same masking of the upper surface. With a diameter (D) of the recess 40.1 and a thickness 50, 51 (d) of the glass ceramic cooking plate 11, the maximum viewing angle 55 (α) for a light-emitting element 23 or a display 21 directly arranged on the lower surface 11.2 of glass ceramic cooking plate 11 is obtained from equation

α=arctan(D/(2·d)).

For a diameter D of the recess 40.1 of 2 mm, a maximum viewing angle 55 of 14° is obtained for a glass ceramic cooking plate 11 of 4 mm thickness, while in case of a glass ceramic cooking plate 11 of 3 mm thickness a maximum viewing angle 55 of 18.4° is possible. Similarly, for a diameter D of the recess 40.1 of 4 mm and a glass ceramic cooking plate 11 of 4 mm thickness, a maximum viewing angle of 25.6° is obtained, and for a glass ceramic cooking plate 11 of 3 mm thickness an angle of 33.7°.

FIG. 5 schematically illustrates a section of a glass ceramic cooking plate 11 with a light-emitting element 23. Similarly to FIG. 4, the light-emitting element 23 is arranged directly on the lower surface 11.2 of a glass ceramic cooking plate 11 that has a reduced thickness 50. For the following consideration, an isotropic radiation distribution of the light-emitting element 23 is assumed. Illustrated is a light beam 54.1 that passes vertically through the glass ceramic cooking plate 11, and a light beam 54.2 that extends obliquely, at a viewing angle 55. The path along which the vertically propagating light beam 54.1 runs within glass ceramic cooking plate 11 corresponds to the reduced thickness 50 of the present example. The path along which the obliquely propagating light beam 54.2 runs within glass ceramic cooking plate 11 is longer, proportionally to the viewing angle 55, as indicated in the view by a double arrow 52. Because of the longer path within glass ceramic cooking plate 11, the intensity of the obliquely propagating light beam 54.2 when exiting from glass ceramic cooking plate 11 will be lower than that of the vertically propagating light beam 54.1, due to increased absorption losses. The illustrated viewing angle 55 represents the angle at which the intensity of the obliquely propagating light beam 54.2 corresponds to 50% of that of the vertically propagating light beam 54.1, after having left the glass ceramic cooking plate 11 in each case.

Spectral transmittance τ is calculated as the ratio of the intensity of the radiation after and before passage through a medium. According to Lambert-Beer's law, the spectral transmittance τ of a glass ceramic cooking plate 11 of a thickness d1 can be converted into a spectral transmittance τ of a glass ceramic cooking plate 11 of a thickness d2 as follows:

τ_{i(d2)}=τ_{i(d1)}·e^{(∈·c·(d1-d2))}, or

τ_{i(d2)}=τ_{i(d1)}^{d1/d2},

wherein ∈ is the extinction coefficient, c is the colorant concentration, and τᵢ is the internal transmittance. In Lambert-Beer's law, spectral transmittance always refers to internal transmittance τᵢ, that means only to the transmitted portion of the total luminous flux. Reflected portions have already been subtracted from the total luminous flux herein.

From this, the viewing angle 55 at which light intensity of the oblique light beam 54.2 is 50% of that of the vertical light beam 54.1 can be calculated for different wavelengths and hence different transmission coefficients of the glass ceramic and for different thicknesses 50, 51 of the glass ceramic cooking plate 11. In case of a transmittance τ of 0.25% based on a glass ceramic cooking plate 11 of 4 mm thickness under perpendicular light transmission, a viewing angle 55 of 26.3° is resulting. For the same glass ceramic material and the same wavelength, the viewing angle 55 for a glass ceramic cooking plate 11 of 3 mm thickness is calculated to be 29.9°. When assuming a transmittance τ of 0.80% and vertical passage of light through a glass ceramic cooking plate 11 of 4 mm thickness, a viewing angle 55 of 29.0° is resulting, while a glass ceramic cooking plate 11 of 3 mm thickness and made of the same glass ceramic material has an viewing angle 55 of 32.8°.

Accordingly, by employing a glass ceramic cooking plate 11 of reduced thickness 50, the viewing angle 55 at which for instance a display 21 can still be read with sufficient brightness can be improved significantly.

A further advantage of the reduced thickness 50 of the glass ceramic cooking plate 11 is resulting with respect to the discoloration of light-emitting elements 23 or displays 21 arranged below the glass ceramic cooking plate 11, in particular in the case of wide-spectrum light-emitting elements or displays, especially in the case of white light. The ratio V of the transmittance for two wavelengths w1 and w2 at two thicknesses 50, 51 d1, d2 of the glass ceramic cooking plate 11 is considered as a measure of discoloration.

If the coloration of glass ceramic cooking plate 11 is adapted to a reduced thickness 50, the product of colorant concentration c, extinction coefficient ∈, and thickness 50, 51 d and hence the extinction according to E=∈·c·d remains the same.

The reduction of the thickness 50, 51 of glass ceramic cooking plate 11 thus has no effect on discoloration.

If the colorant concentration of the thinner glass ceramic cooking plate 11 is chosen to be the same as that of the thicker glass ceramic cooking plate 11, which means that the thinner glass ceramic cooking plate 11 presents a lower optical density, an improvement obtainable in terms of discoloration can be demonstrated for the thinner glass ceramic cooking plate 11 as compared to the thicker glass ceramic cooking plate 11:

V1=τ(w1,d1)/τ(w2,d1)

V2=τ(w1,d2)/τ(w2,d2)

With Lambert-Beer's law, the following can be derived (with the approach of τ=P·τᵢ the factor P is cancelled out in the consideration of the τ ratios and sot can be used instead of τᵢ):

V1=V2^{(d1/d2-1)}=V2^{(d1/d2-2)}·V2=K·V2

K=V2^{(d1/d2-2)}.

For a known glass ceramic cooking plate this gives, by way of example:
w1=470 nm; w2=630 nm; d1=3 mm; d2=4 mm
V1=12.6%; V2=6.3%; K=1.99.

Accordingly, discoloration according to the ratio τ(470 nm)/τ(630 nm) improves from V1=6.3% for the case of a glass ceramic cooking plate 11 of 4 mm thickness to V2=12.6% for the case of a glass ceramic cooking plate 11 of 3 mm thickness.

As a result of the reduced discoloration, white balance for light-emitting elements 23 and displays 21 is facilitated. Light-emitting elements and displays arranged below glass ceramic cooking plate 11 will appear less discolored in case of a reduced thickness 50 of the glass ceramic cooking plate 11.

The reduced discoloration has a particular impact under an oblique view to the light-emitting element 23 or display 21. Therefore, warning messages which are preferably signaled by different colors of the light-emitting element 23 or the display 21 can be better perceived.

FIG. 6a shows a schematic side view of a section of a glass ceramic cooking plate 11 with a knobbed lower surface 11.2 and a display 21 arranged therebelow with a spacing 53. The display 21 is in the form of a seven-segment display in the present example.

A light beam 54 emitted from display 21 passes through the glass ceramic cooking plate 11. Knobs 11.3 molded into the lower surface 11.2 of glass ceramic cooking plate 11 have an effect of small lenses so that the light beam 54 is refracted differently, depending on the location at which it is incident on the glass ceramic cooking plate 11.

FIG. 6b is a plan view of the portion of the glass ceramic cooking plate 11 shown in FIG. 6a. Due to the effect of knobs 11.3, the display 21 is strongly distorted. This effect is even aggravated with an increasing spacing between the display 21 and the lower surface 11.2 of glass ceramic cooking plate 11. Therefore, in the case of a knobbed lower surface of glass ceramic cooking plate 11 as required for prior art glass ceramic cooking plates 11 it is not possible to represent finely patterned symbols, and even in the case of coarser symbols error-free reading might be difficult.

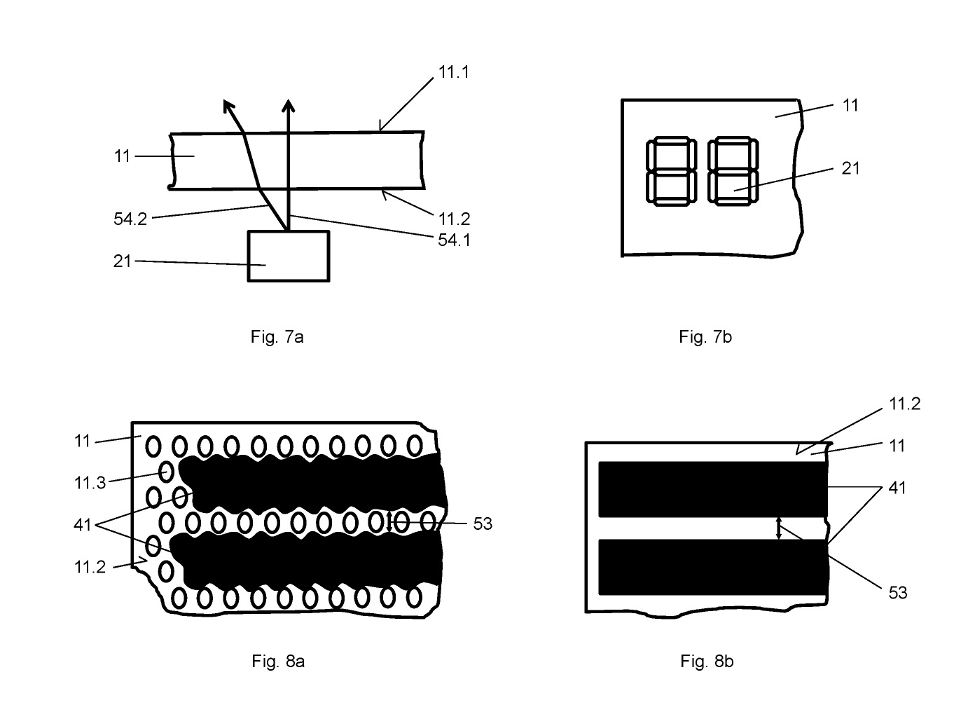

FIG. 7a is a schematic side view of a section of a glass ceramic cooking plate 11 with a smooth lower surface 11.2 and a display 21 arranged with a spacing thereto. Similar to FIGS. 6a and 6b, the display is again in the form of a seven-segment display. With the described glass ceramic cooking plate 11 of the invention, such a smooth, non-textured lower surface 11.2 is even made possible in case of a reduced thickness 50, while the requirement in particular in terms of impact strength of the glass ceramic cooking plate 11 are still met.

FIG. 7b is a plan view of the portion of a glass ceramic cooking plate 11 shown in FIG. 7a. In contrast to the view in FIG. 6b, the display 21 appears with sharp contours and without distortions. Due to the non-textured lower surface 11.2 and the low fraction of diffused light (haze) of the glass ceramic cooking plate 11 according to the invention, even finely patterned symbols can be imaged and recognized across the glass ceramic cooking plate 11.

FIG. 8a schematically illustrates a bottom view of a section of a glass ceramic cooking plate 11 with a knobbed lower surface 11.2. Here, knobs 11.3 are arranged regularly on the lower surface 11.2.

Two strips of a coating 41 are applied on the lower surface 11.2 with a spacing 53 from each other. The strips are representative of a number of possible coatings 41 which may be applied on the lower surface 11.2 of glass ceramic cooking plate 11 and which may have different functions. For example, the coating 41 may be provided as an opaque diffusion light barrier. Such diffusion light barriers are preferably applied outside the hot zones of the glass ceramic cooking plate 11 in order to prevent an insight into the cooktop 10 through the glass ceramic cooking plate 11 even under strong incident light.

In another application, a transparent and colored coating 41 may be applied in the region of a display 21 or of a light-emitting element 23. Such a colored coating 41 may serve to adapt the color appearance of the display 21 or light-emitting element 23 across the glass ceramic cooking plate 11 by subtractive color mixing.

The coating 41 may as well consist of an electrically conductive material which may be provided in transparent form, for example as an ITO layer, or in opaque form, for example as a gold coating. Such a conductive coating 41 may serve to produce the electrodes 22.1 of a capacitively effective touch sensor 22 shown in FIG. 3, for example. If these electrodes 22.1 are transparent, a display 21 or a light-emitting element 23 may be arranged behind them. Such a display 21 may allow for intuitive user guidance.

In dependence of the respective display content, a different switching process is triggered by the touch sensor 22.

It is also conceivable that an electrically conductive coating 41 extends into a hot zone of the glass ceramic cooking plate 11. There, the coating 41 may be in the form of an area element or of a conductor track of a sensor. Such a sensor makes it possible, for example, to determine the temperature of the glass ceramic cooking plate 11 in the hot zone. For this purpose, a change in resistance along a conductor track defined by the electrically conductive coating 41 can be measured and evaluated. It is also possible to measure the electrical resistance of the glass ceramic cooking plate 11 itself between two conductor tracks arranged at a spacing 53 from each other and to determine the glass ceramic temperature therefrom. Such a temperature measurement allows for a variety of features and functions, for example limitation of a maximum temperature of the glass ceramic cooking plate 11, or power redistribution between the heating circuits of a multi-circuit heater in dependence of the quality of the placed piece of cookware. Such a sensor may furthermore be adapted to detect a placed pot or its size. Capacitively and inductively effective methods are known for this purpose.

A drawback for the applications mentioned above is the lack of sharp contours of the coating 41 as caused by the knobs 11.3 in dependence of the selected coating method. Possible coating methods include screen printing, spraying, and vapor deposition. Due to the lack of sharp contours, it is not possible to produce neighboring coated regions with an exactly consistent spacing 53 therebetween. Symbols that are provided as backlit recesses in diffusion light barriers can therefore only be visualized with rough details. Electrical measurements between adjacent sensor conductor tracks might be corrupted due to the varying spacing 53. Similarly, it is not possible to produce electrodes 22.1 or sensor area elements, for example, with exactly consistent surface areas. This may cause malfunctions for example in the operation of capacitively effective touch sensors or of capacitively effective sensor area elements for pot detection.

FIG. 8b schematically illustrates a bottom view of a section of a glass ceramic cooking plate 11 according to the invention with a non-textured lower surface 11.2. In contrast to the coating 41 on a knobbed lower surface 11.2 as shown in FIG. 8a, the coating 41 of the smooth lower surface 11.2 has sharp contours. Thus, the aforementioned drawbacks resulting for the various possible applications from a lack of sharp contours of the coating 41 can be effectively avoided.

A further advantage in this context is the increased strength of the glass ceramic cooking plate 11 according to the invention. Coatings on the lower surface 11.2 of a glass ceramic cooking plate 11 often have a strength reducing effect on the glass ceramic cooking plate 11, depending on the selected coating material and coating process. This loss in strength can be compensated for by the increased strength of the glass ceramic cooking plate 11 of the invention. As a result, several types of coatings 41 are even made possible at all without inadmissibly reducing the strength of the glass ceramic cooking plate 11.

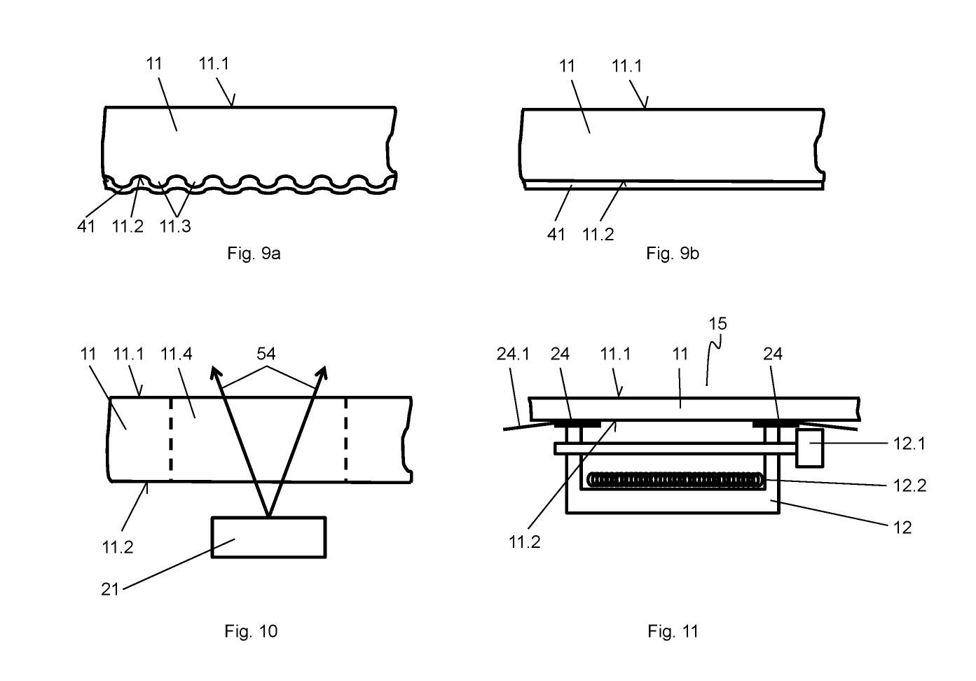

FIG. 9a is a schematic side view of a section of a knobbed glass ceramic cooking plate 11 with a coating 41 on the lower surface, which has already been described in terms of its structure and function with reference to FIGS. 8a and 8b.

Because of the knobbed texture, coating 41 is formed with an inconsistent layer thickness. In particular, the layer has a greater thickness in the valleys between the knobs and a smaller thickness on top of the knobs. Such an inhomogeneous layer thickness may lead to adverse effects on the previously described functions of the coating 41. For example, if opaque diffusion light barriers are desired, translucent regions might be created on the tops of the knobs, which will appear as undesirable light points when the glass ceramic cooking plate 11 is backlit. Furthermore, it is not possible to produce conductive coatings 41 with sufficiently precise electrical resistances.

FIG. 9b is a schematic side view of a section of a non-textured glass ceramic cooking plate 11 with a coating 41 on the lower surface.

Because of the smooth lower surface 11.2 of the glass ceramic cooking plate 11 according to the invention, the coating 41 provided on the lower surface has a very homogeneous and uniform layer thickness. The drawbacks described with reference to FIG. 9a for a coating 41 on a prior art glass ceramic cooking plate 11 that has a knobbed lower surface can thus be avoided.

FIG. 10 is a schematic side view of a section of a glass ceramic cooking plate 11 with a display region 11.4.

The display region 11.4 which is delimited by dashed lines exhibits increased transmittance compared to the surrounding glass ceramic material. Display region 11.4 has associated therewith a display 21 that is provided below the glass ceramic cooking plate 11.

Because of the increased transmittance of the glass ceramic cooking plate 11 in display region 11.4, only a small portion of the light beam 54 emanating from display 21 is absorbed. At the same time, transmittance in the display region 11.4 may be adapted over the wavelength range of visible light in a manner so that discoloration of the transmitted light beam 54 is lower compared to the surrounding glass ceramic material. Hence, in the display region 11.4 of glass ceramic cooking plate 11, displays 21 and light-emitting elements 23 can be presented with greater brightness and lower offset in their color coordinates (in particular in case of wide-spectrum light-emitting elements or displays, especially in case of white light). Moreover, the viewing angle of the display is improved due to the brightening, as already explained before.

For creating such a display region 11.4, the glass ceramic cooking plate 11 contains suitable color-imparting metal ions. Such metal ions initially cause a desired volume coloration of the glass ceramic cooking plate 11. By partially heating the glass ceramic cooking plate 11, for example using a laser, and with subsequent rapid cooling, the volume coloration can be cancelled at least partially. In this way it is possible to produce display regions 11.4 with improved light transmittance within glass ceramic cooking plate 11.

FIG. 11 is a schematic side view of a section of a cooktop 10 with a glass ceramic cooking plate 11, a heater 12, and sensor electrodes 24. The sensor electrodes 24 in the form of two-dimensional metal electrodes are arranged between the edge of heater 12 and the lower surface 11.2 of glass ceramic cooking plate 11. They are connected to suitable evaluation electronics via corresponding connection lines 24.1.

Sensor electrodes 24 together with the associated evaluation electronics provide for capacitive detection of a piece of cookware, not shown, which is placed in the region of cooking zone 15.

Because of the smooth lower surface of the glass ceramic cooking plate 11 according to the invention, the sensor electrodes 24 can be pressed over their entire surface area against the lower surface 11.2 of glass ceramic cooking plate 11. Gaps which in the case of a textured lower surface 11.2 are inevitably caused between the sensor electrodes 24 and the glass ceramic cooking plate 11, for example in the valleys between knobs, can be avoided. This prevents dirt and in particular moisture from accumulating between the sensor electrodes 24 and the lower surface 11.2 of glass ceramic cooking plate 11 and from interfering with the functionality of the sensor. Due to the reduced thickness 50 of the glass ceramic cooking plate 11 according to the invention, the spacing between sensor electrodes 24 and a placed piece of cookware decreases. This causes an increase in sensitivity of the capacitive sensor according to the capacitor formula described above. Thus, with the smooth lower surface 11.2 and the reduced thickness 50 of the glass ceramic cooking plate 11 according to the invention, the sensitivity and reliability of the described system for detecting a pot and the pot's size can be significantly improved.

In summary, it can be stated that with the cooktop of the invention comprising the glass ceramic cooking plate 11 according to the invention, the interface between the cooktop 10 and a user can be significantly improved. The interface is defined in this case by respective touch sensors 22 arranged below the glass ceramic cooking plate 11, and preferably by associated light-emitting elements 23 and/or displays 21. The interface may furthermore have associated therewith additional sensors which provide for easier control of the cooktop.

The properties of the glass ceramic cooking plate 11 of the invention can be advantageously exploited for a number of further applications. For example it is possible, by suitably coating the lower surface, to apply resistive tracks to the glass ceramic lower surface 11.2, directly or separated by an insulating intermediate layer. By supplying electrical energy, the resistive tracks can be heated and therefore be used as a heater 12. The non-textured lower surface of the glass ceramic cooking plate 11 permits to apply the resistive tracks, and optionally the insulating layer, with significantly improved contour definition and thickness variation. The electrical resistance of the resistor tracks and hence the electrical power of the heater 12 defined thereby can therefore be produced with significantly better reproducibility.

Because of the reduced thickness 50 of the glass ceramic cooking plate 11 according to the invention, the spacing between the induction coil of an induction heater that is employed as a heater 12 and a placed piece of cookware decreases as well. This leads to an improved coupling between the cookware and the magnetic alternating field of the induction heater, resulting in improved energy transfer with reduced energy losses.

Glass ceramic cooking plate 11 may furthermore be perforated by bores, for example for toggles or gas heaters that extend through the bores.

For other applications, it is furthermore possible that a glass ceramic plate similar to the glass ceramic cooking plate 11 of the invention is designed as a cover glass for a spotlight, for example a construction site spotlight, or as a soleplate of a flat iron, or as a separating member between a heater and a utility space in a toaster, or as a baking tray, or as a cover for a radiant heater or an oven heater.

It is also conceivable to provide a gas burner cover made of the glass ceramic according to the invention for a gas burner of a gas stove, preferably a gas stove that comprises a glass ceramic cooking plate 11.

In these applications, too, the glass ceramic with its increased strength and reduced thickness 50 which is made possible thereby brings about significant improvements in terms of energy transfer, energy loss as well as operability and controllability of the respective appliances.

LIST OF REFERENCE NUMERALS:

| | |
|---|---|
| 10 | Cooktop |
| 11 | Glass ceramic cooking plate |
| 11.1 | Upper surface |
| 11.2 | Lower surface |
| 11.3 | Knobs |
| 11.4 | Display region |
| 12 | Heater |
| 12.1 | Protective temperature limiter |
| 12.2 | Heating coil |
| 13 | Spring element |
| 14 | Bottom of cooktop |
| 15 | Cooking zone |
| 16 | Frame |
| 16.1 | Adhesive |
| 20 | Electronic arrangement |
| 21 | Display |
| 22 | Touch sensor |
| 22.1 | Electrodes |
| 22.2 | Circuit board |
| 22.3 | Electrical field |
| 22.4 | Infrared radiation |
| 23 | Light-emitting element |
| 24 | Sensor electrode |
| 24.1 | Connection line |
| 30 | Energy flow |
| 31 | Transverse heat conduction |
| 40 | Upper surface coating |
| 41 | Coating |
| 50 | Reduced thickness |
| 51 | Usual thickness |
| 52 | Double arrow |
| 53 | Spacing |
| 54 | Light beam |
| 54.1 | Vertical light beam |
| 54.2 | Obliquely propagating light beam |
| 55 | Viewing angle |
| 56 | Opening angle |
| 57.1 | First illuminated area |
| 57.2 | Second illuminated area |

What is claimed is:

1. A cooktop, comprising:
a glass ceramic cooking plate;
at least one heater arranged below the glass ceramic cooking plate; and
at least one touch sensor operable across the glass ceramic cooking plate for adjusting a power of the at least one heater, the at least one touch sensor is indirectly or directly connected to or urged against or in a spacing of the glass ceramic cooking plate,
wherein the glass ceramic cooking plate is made of a lithium aluminosilicate glass ceramic containing a composition (in percent by weight) of:

| | |
|---|---|
| Al₂O₃ | 18-23, |
| Li₂O | 2.5-4.2, |
| SiO₂ | 60-69, |
| ZnO | 0-2, |
| Na₂O + K₂O | 0.2-1.5, |
| MgO | 0-1.5, |
| CaO + SrO + BaO | 0-4, |
| B₂O₃ | 0-2, |
| TiO₂ | 2.3-4.5, |
| ZrO₂ | 0.5-2, |
| P₂O₅ | 0-3, |
| SnO₂ | 0-<0.6, |
| Sb₂O₃ | 0-1.5, |
| As₂O₃ | 0-1.5, |
| TiO₂ + ZrO₂ + SnO₂ | 3.8-6, |
| V₂O₅ | 0.01-0.08, |
| Fe₂O₃ | 0.03-0.3, |

and
wherein the glass ceramic cooking plate has a core and includes keatite mixed crystals as a predominant crystal phase in the core,
wherein the keatite mixed crystals have a crystal phase content that exceeds 50% a total crystal phase content of high-quartz mixed crystals and keatite mixed crystals in a depth of 10 μm or more, and
wherein the glass ceramic cooking plate has a thickness in a range between 2.8 mm and 3.5 mm.

2. The cooktop as claimed in claim 1, wherein the composition further comprises coloring oxides up to a maximum amount of 1.0 wt %.

3. The cooktop as claimed in claim 1, wherein the thickness is between 2.8 mm and 3.2 mm.

4. The cooktop as claimed in claim 1, wherein the glass ceramic cooking plate has a gradient layer at a surface or towards the surface thereof, the core being located below the gradient layer, and wherein the glass ceramic cooking plate includes the keatite mixed crystals as the predominant crystal phase in the core and the high-quartz mixed crystals as the predominant crystal phase in the gradient layer.

5. The cooktop as claimed in claim 1, comprising a maximum haze of not more than 6% at a wavelength of 630 nm.

6. The cooktop as claimed in claim 1, wherein the at least one touch sensor is a capacitive sensor.

7. The cooktop as claimed in claim 1, wherein the at least one touch sensor is an optical sensor.

8. The cooktop as claimed in claim 1, further comprising at least one light-emitting element and/or at least one self-luminous or externally illuminated display arranged indirectly or directly adjacent to a lower surface of the glass ceramic cooking plate or spaced from the lower surface of the glass ceramic cooking plate, wherein the light-emitting element and/or the display shines through the glass ceramic cooking plate.

9. The cooktop as claimed in claim 8, further comprising an intermediate layer that is disposed indirectly or directly between the touch sensor and/or the light-emitting element and/or the at least one display and the glass ceramic cooking plate, wherein the intermediate layer is selected from the group consisting of a transparent layer, a colored transparent layer, a non-transparent layer, and a light-diffusing layer.

10. The cooktop as claimed in claim 1, wherein the glass ceramic cooking plate has a lower surface that is not textured.

11. The cooktop as claimed in claim 1, wherein the glass ceramic cooking plate has a lower surface that is provided, at least in sections thereof, with a diffusion light barrier, the diffusion light barrier is not transparent in the visible spectral range.

12. The cooktop as claimed in claim 1, wherein the at least one touch sensor comprises a component selected from the group consisting of a sensor area element, a sensor conductor track, a sensor contact point, and combinations thereof, wherein the component is applied indirectly on or directly on or urged against the glass ceramic cooking plate.

13. The cooktop as claimed in claim 1, comprising a haze of not more than 15% at a wavelength of 470 nm normalized to a glass ceramic cooking plate of 4 mm thickness.

14. The cooktop as claimed in claim 1, comprising a maximum fraction of diffused light of not more than 20% in a range of wavelengths from 400 nm to 500 nm normalized to a glass ceramic cooking plate of 4 mm thickness.

15. The cooktop as claimed in claim 1, comprising light transmittance in a range of wavelengths from 380 nm to 780 nm of less than or equal to 5% normalized to a glass ceramic cooking plate of 4 mm thickness.

16. The cooktop as claimed in claim 1, comprising a spectral transmittance that is greater than 0.2% at a wavelength of 420 nm.

17. The cooktop as claimed in claim 1, wherein the glass ceramic cooking plate comprises color-imparting metal ions, wherein the glass ceramic cooking plate has a display region with a spectral transmittance that is increased in some areas as compared to an adjacent region due to local heating induced by electromagnetic radiation on the color-imparting metal ions.

18. The cooktop as claimed in claim 17, wherein the display region has a light transmittance of less than or equal to 10% in a range of wavelengths from 380 nm to 780 nm.

19. The cooktop as claimed in claim 17, wherein the display region has a light transmittance of less than or equal to 2.5% in a range of wavelengths from 380 nm to 780 nm.

20. The cooktop as claimed in claim 17, further comprising at least one light-emitting element and/or at least one self-luminous or externally illuminated display arranged indirectly or directly adjacent to a lower surface of the glass ceramic cooking plate or spaced from the lower surface of the glass ceramic cooking plate under the display region, wherein the light-emitting element and/or the display shines through the display region.
